(19) United States
(12) Patent Application Publication
(10) Pub. No.: US 2026/0356373 A1
(43) Pub. Date: Nov. 12, 2026

(54) COMPUTER-IMPLEMENTED METHOD FOR ASSESSING UNCERTAIN TIME EFFECTS WHEN CONTROLLING A SYSTEM, IN PARTICULAR FOR A VEHICLE, IN THE CASE OF STOCHASTIC UNCERTAINTIES

(71) Applicant: Robert Bosch GmbH, Stuttgart (DE)

(72) Inventors: Stefan Grodde, Stuttgart (DE); Andreas Gauger, Brackenheim (DE); Antoine Vandamme, Gerlingen (DE); Kevin Schmidt, Herrenberg (DE); Lance Bredthauer, Livonia, MI (US); Steffen Joos, Walheim (DE)

(21) Appl. No.: 19/641,945

(22) Filed: Apr. 8, 2026

(30) Foreign Application Priority Data
Apr. 11, 2025 (DE) 10 2025 114 323.4

(51) Int. Cl. B60W 50/00

(52) U.S. Cl. CPC B60W 50/00; B60W 2050/0031; B60W 2050/0043; B60W 2556/20

(57) ABSTRACT

A computer-implemented method is for evaluating uncertain time effects when controlling a system based on one or more state variables of the system, particularly for a vehicle. The method classifies the uncertain time effects in the case of stochastic uncertainties in the control loop as critical or non-critical for controlling the system.

This application claims priority under 35 U.S.C. § 119 to patent application no. DE 10 2025 114 323.4, filed on Apr. 11, 2025 in Germany, the disclosure of which is incorporated herein by reference in its entirety.

The present disclosure relates to techniques for evaluating uncertain time effects in controlling a system with respect to one or more state variables of the system. Related aspects relate to a computer program, a computer system and a computer readable medium or signal.

### BACKGROUND

Highly automated or autonomous systems are an increasingly important area of focus in the robotics and automotive industries, for example. Control systems in particular are of increasing importance in the operation of autonomous or highly automated systems. Although numerous methods have been proposed for controlling driving functions, these are mostly based on nominal models, i.e., uncertain time effects (in other words, temporal uncertainties) in connection with external disturbances (changing environmental factors such as a slippery roadway, side wind, etc.), vehicle-specific changes (e.g., high payload or continuous tire wear), and time delays/variations in the evaluation of sensor signals (e.g., camera, lidar, or radar) and associated delays/variations throughout the entire chain of action (e.g., delay in lateral control) are not sufficiently considered.

For example, due to varying physical conditions in distributed systems affecting signal transmission, or due to varying channel utilization in vehicle-to-vehicle (V2V) communication, for example, time delays and additionally varying sampling times may occur that are non-deterministic (i.e., of a stochastic nature) and thus uncertain. For example, networked adaptive speed control, group start, or cooperative merging of traffic lanes may be situations where channel utilization is unusually high relative to other situations. For example, non-deterministic delays and/or jitter may result in the feedback circuit, in bus communication when distributed E/E architectures are involved in vehicle control functions, and/or in signal processing and transmission in sensor systems. In control systems, such as longitudinal control or lateral control of a vehicle, this non-deterministic time delay may adversely affect control success. Moreover, other uncertain time effects (in connection with internal or external disturbances), such as a time-varying external wind force while a vehicle is traveling, or other time effects (of a non-deterministic nature), such as the cornering stiffness of the front and/or rear axle of the vehicle, may negatively affect control success if these time effects are not sufficiently evaluated.

In addition, the time effects discussed above are unknown in the development phase and the parameterization of the controller or may be quantified only with difficulty. Therefore, at a later stage in the application phase the controllers must be intensively tested and adjusted against the uncertainties. This is time consuming and costly. Particularly in the context of ever shorter development cycles, also driven by the increasing software content, market-specific disadvantages result from long product provision times. Another challenge is the high computing or implementation effort needed to obtain reliable information about the dispersion of the target variables. This may include sampling-based simulation methods, for instance, (e.g., Monte Carlo simulation, non-intrusive uncertainty quantification (UQ) methods) that require a large number of function calls.

For these reasons, there is a need for new improved techniques for evaluating uncertain time effects when controlling a system.

### SUMMARY

A first general aspect of the present disclosure relates to a computer-implemented method for evaluating uncertain time effects when controlling a system based on one or more state variables of the system. The method comprises receiving a time-continuous dynamic model for describing the system to be controlled, wherein the time-continuous dynamic model is represented by a specified function. The predefined function of the first aspect includes the following time-dependent arguments: a state vector comprising one or more state variables; an input vector comprising one or more input variables connected to the state vector by a feedback matrix describing a state controller of the system, and an uncertainty vector with at least one component comprising a time-dependent uncertainty parameter representing a stochastic process linked to an uncertain time effect. Moreover, the method comprises: forming a time-discrete representation of the time-continuous dynamic model by time discretization of the time-continuous dynamic model and determining a surrogate model of the time-discrete representation of the state-space model. Furthermore, the method comprises: solving the surrogate model to determine a mean of the state vector and a deviation, in particular a variance, of the state vector at a plurality of discrete time points; searching for one or more discrete time points from the plurality of discrete time points using the determined mean of the state vector and the determined deviation, in particular the variance, of the state vector, at which a specified rough requirement criterion for the state vector is not satisfied. Finally, the first aspect of the present disclosure comprises classifying the uncertain time effects as critical for controlling the system if the one or more discrete time points have been identified, for which the rough requirement criterion for the state vector is not satisfied, and otherwise classifying the uncertain time effects as non-critical for controlling the system.

A second general aspect of the present disclosure relates to a computer program designed to perform the computer-implemented method for evaluating uncertain time effects when controlling a system based on one or more state variables of the system according to the first general aspect.

A third general aspect of the present disclosure relates to a computer system designed to perform the computer-implemented method for evaluating uncertain time effects when controlling a system based on one or more state variables of the system according to the first aspect and/or the computer program according to the second aspect.

A fourth general aspect of the present disclosure relates to a computer-readable medium or signal, which stores and/or contains the computer program according to the second general aspect.

The techniques of the first to fifth general aspects may have one or more of the following advantages.

Firstly, the techniques of the present disclosure serve to provide a method for evaluating uncertain time effects in a system to be controlled. In particular, the proposed methods may allow a small number of simulation steps (in some cases even only one simulation) to be sufficient to characterize/quantify the influence of time-dependent uncertainties on a control system, in particular to determine which uncertain time effects may be critical for controlling the system and which may not. The small number of simulation steps used in this case may represent a significant efficiency gain (in terms of computational time and hardware resources) over a high number of simulations using inefficient UQ methods of the prior art. This may lead to savings on the one hand in terms of runtime and on the other hand in terms of the computing resources necessary for the simulation.

Secondly, the presented techniques may, by way of the discrete-time representation of the dynamic model taking into account the time-dependent uncertainty parameter based on the stochastic process, allow a better representation of reality, in particular in distributed control systems, and thus the evaluation of uncertain time effects when controlling the system may be improved.

Another advantage may be to reduce the time-to-market of highly automated control functions, because relevant temporal uncertainties may already be taken into account in the development phase. This may reduce the effort which would need to be expended in the verification/validation phase. With the presented techniques, meaningful statements may, in particular, be made during the development phase as to whether specified requirements (e.g., customer-specific requirements) are met and/or legal requirements (e.g., automotive industry standards/safety standards) for the function of a system to be controlled (e.g., for lateral guidance of the vehicle) are complied with despite the influence of the temporal uncertainties occurring in this system.

Some terms are used in the present disclosure in the following manner: A “state controller” may comprise an algorithm, i.e., a calculation specification, that returns a full or partial state variable (i.e., the internal state of the control section) for an input variable. A state controller may include parameters that may weight the state variable. In some examples, a state controller may be executed on a computer system. In some examples, a state controller may be executed in a controller of a vehicle, cloud, or edge. For example, a state controller may include or be part of a hardware module having inputs and outputs. In the examples, a state controller may be a controller, a part of the controller, or the controller itself.

In one example, the “system to be controlled” in the present disclosure may be designed to be arranged within a vehicle and/or designed to control a vehicle function (in particular, to control a travel function). For example, the vehicle function may be an autonomous and/or assisted driving function. In some examples, the state controller may be configured for execution on a computer system of a vehicle (e.g., an autonomous, highly automated, or assisted driving vehicle). For example, the computer system may be implemented locally in the vehicle or (at least in part) may be implemented in a backend communicatively connected to the vehicle. For example, the computer system may comprise a controller on which the state controller may be executed. In some examples, the vehicle may comprise a computer system having a communication interface that enables communication with a backend. For example, the state controller may be executed in this backend. In some examples, the temporal uncertainties may arise from the data transfer between the system to be controlled and the computer system executing the state controller. In one example, the “system to be controlled” may be a system for lateral guidance and/or longitudinal guidance of the vehicle. In some examples, a “state vector” may be based on speed information or distance information. In some examples, the state vector may comprise a relative speed and/or a distance between a first vehicle, a second vehicle, a human, and/or a stationary object. In one example, the “state vector” may comprise state variables that are based at least on one of a steering angle, an orientation angle, a yaw rate, a slip angle, and/or a lateral error. In some examples, the state vector may comprise information from a network, such as movement and/or direction information from other vehicles. In some examples, this information may be provided by vehicle-to-vehicle (V2V) communication or by a backend (V2X) communication. In some examples, the “state vector” may comprise state variables based on one or more sensor signals. In some examples, these sensor signals may be generated by corresponding sensors, such as lidar sensors, radar sensors, cameras, ultrasonic sensors, GPS, accelerometers, temperature sensors, and the like. In one example, an “input vector” may comprise a steering angle, a steering speed or targets for acceleration and/or braking operations. In some examples, the “system to be controlled” may be designed to be arranged in an engine controller or power unit and/or used to regulate an engine-related function (in particular, for engine control). In some examples, the “system to be controlled” may be designed to be arranged in a drive control of an electric machine. For example, “the state vector” may contain components based on at least one of a control signal, an operating mode, or a power setting of the electric machine.

In the context of the present disclosure, it is also conceivable that “the system to be controlled” may be arranged in a robot and/or configured to control a robot function (in particular for controlling a travel function of a robot and/or a movement function of a robot, e.g., of robot arms). For example, the “system to be controlled” may be a system for lateral guidance and/or longitudinal guidance of the robot. In some examples, the state controller may be executed on a computer system of a robot. For example, the computer system may be implemented locally in the robot or (at least in part) may be implemented in a backend communicatively connected with the robot. In some examples, the state controller may be executed in a backend. In some examples, “the state vector” may be based on speed information or distance information. In some examples, the “state vector” may comprise a relative speed and/or a distance between a first robot, a human, another mobile device, and/or a stationary object. In one example, the state vector may comprise state variables that are based at least on one of a steering angle, an orientation angle, a yaw rate, a slip angle, and/or a lateral error. In some examples, the state vector may comprise information from a network, such as movement and/or direction information from other robots, mobile devices, and/or humans. In some examples, this information may be provided via direct communication or by a backend. In some examples, the “state vector” may comprise state variables based on one or more sensor signals. In some examples, these sensor signals may be generated by corresponding sensors, such as lidar sensors, radar sensors, cameras, ultrasonic sensors, GPS, accelerometers, temperature sensors, and the like. In one example, an “input vector” may comprise a steering angle, a steering speed or targets for acceleration and/or braking operations.

Moreover, “the system to be controlled” may be directed for control of distributed systems, for example for longitudinal vehicle guidance of multiple vehicles (“platooning” is an example). In addition to longitudinal vehicle guidance, “the system to be controlled” may provide control of distributed systems, such as automated guided vehicles (AGV). This control may be adapted, for example, to drive and/or coordinate driverless transport vehicles in a restricted area, in particular, in a logistics center and/or production plant, using a local network (e.g., local edge, 5G network, 6G network, etc.). As another example, the distributed systems may comprise robot arms in a local area network, e.g., in a manufacturing system. The control algorithms of at least these robot arms may be at least partially outsourced (i.e., at least partially decentralized).

A “time-dependent uncertainty parameter” within the meaning of the present disclosure may be associated with an “uncertain time effect” of a non-deterministic (e.g., stochastic) nature. This uncertain time effect (sometimes referred to as a “temporal uncertainty”) may occur in the feedback of the control loop of a state controller and thus affect its performance. In other words, “a time-dependent uncertainty parameter” may be understood to mean any uncertainty parameter that is time-variant, i.e., it fluctuates over time and is therefore to be considered a time-dependent scalar in “a system to be controlled”. A “time-dependent uncertainty parameter” may represent a stochastic process associated with an uncertain time effect (e.g., in the feedback of the control loop of a state controller). “A time-dependent uncertainty parameter” may be thus described (in other words, modeled) in some cases by a predefined (in other words, known) stochastic process.

An example of the “uncertain time effect” is the time delay (also called dead time) that represents a delay, with which a change at the input (given, e.g., by an input vector) becomes noticeable in a reaction at the output of a control path in the control loop (e.g., a state vector may thereby change significantly compared to the case in which the time delay is not present). For example, in distributed systems in which the control algorithm is physically performed separately from the system to be controlled (e.g., by way of cloud or edge computing), such time delays in data transfer may occur. The time delay may also be associated with sensor signal acquisition.

A further example of the “uncertain time effect” is jitter, i.e., an accuracy variation in the transmission clock of computing units of the distributed systems, such as a state controller and an actuator of a vehicle, a sensor of the vehicle, and the state controller (or any combination thereof). For example, this jitter may result in time-dependent dispersion of the sampling time of one or more computing units of the distributed system (e.g., of the distributed control system) or may be this time-dependent dispersion of the sampling time in these computing units. For example, in the case of special longitudinal vehicle guidance (e.g., platooning), jitter may be a time-dependent dispersion of the sampling time of a computing unit of the distributed control system that manages the dynamics of one or more vehicles.

Another example of an “uncertain time effect” is a time disturbance in “a system to be controlled” that has an effect on the system (e.g., the vehicle) and thus contributes to feedback of the control loop of the state controller for that system. A time-varying, system-external physical effect is one example of an external disturbance of the system. A time-varying, system-internal physical effect is one example of an internal disturbance of the system. Time-varying external wind force while driving a vehicle and the cornering stiffness of the front and/or rear axle of the vehicle are non-exhaustive examples of such time-uncertain physical effects.

A “dynamic model” for the description of a “system to be controlled” may be a model that quantitatively describes one or more functions of a system (e.g., one or more vehicle functions of a vehicle or one or more robotic functions of a robot). This quantitative description may include, for example, a temporal and/or spatial dependence of one or more “state variables” and/or one or more “input variables” representing the behavior of this function or these functions of the system. Moreover, the “dynamic model” may comprise parameters (e.g., uncertainty parameters defined above), upon which the state variables and/or input variables may be dependent. Alternatively or additionally, “dynamic model” may comprise parameters that may have an impact on the dynamic change in the state variables and/or input variables. The “dynamic model” may be a comprehensive (in the sense of equations, e.g., a system of coupled equations (such as differential equations) for the state variables, input variables and/or uncertainty parameters used for describing the behavior of a function of a device) and computationally complex simulation model. In this context, within the scope of the present disclosure, models may be derived by simplification of the dynamic model (in other words, these models will approximate the dynamic model) that are less computationally intensive than the (original) dynamic model. These simplified models are hereinafter referred to as “surrogate models” in some cases.

A “vehicle” may be any device that transports passengers and/or freight. A vehicle may be a motor vehicle (for example, a car or a truck) but also a rail vehicle. A vehicle may also be a motorized two or three wheel vehicle. However, floating and flying devices may also be vehicles. Vehicles may be at least partially autonomously operating or assisted.

### BRIEF DESCRIPTION OF THE DRAWINGS

FIG. 1A is a flow chart depicting an example of evaluating uncertain time effects when controlling a system with respect to one or more state variables of the system according to the first aspect. FIGS. 1B, 1C, and 1D are flow charts showing further possible method steps according to the first aspect.

FIG. 2 schematically illustrates an exemplary control loop according to one or more embodiments of the present disclosure.

FIG. 3A exemplarily illustrates a resulting response of a specified state controller in the form of a mean and a confidence interval for the lateral error when returning a traveling vehicle to a travel lane using the surrogate model according to techniques of the present disclosure. FIG. 3B shows the distribution for lateral error along with two risk measures (the value-at-risk and the conditional value-at-risk) at a point in time corresponding to a maximum value for the lateral error in the time interval shown in FIG. 3A. FIG. 3C shows one example of a statistical distribution of the cornering stiffness of the front axle of the vehicle.

### DETAILED DESCRIPTION

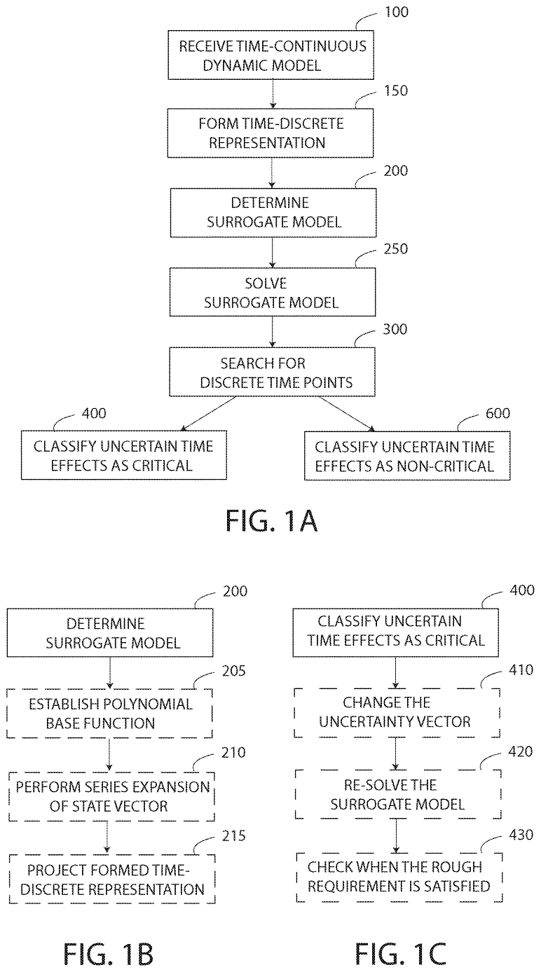

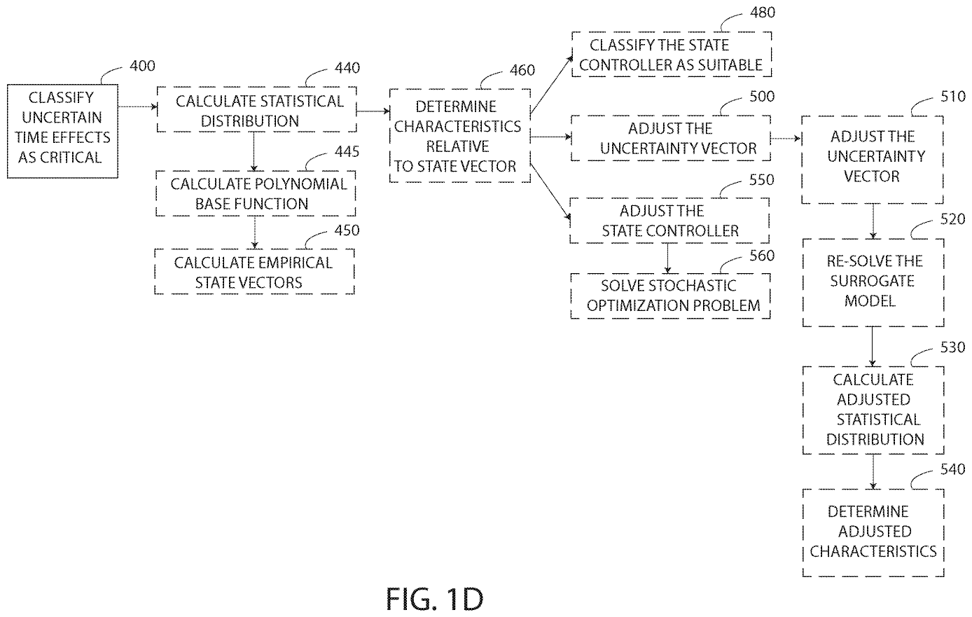

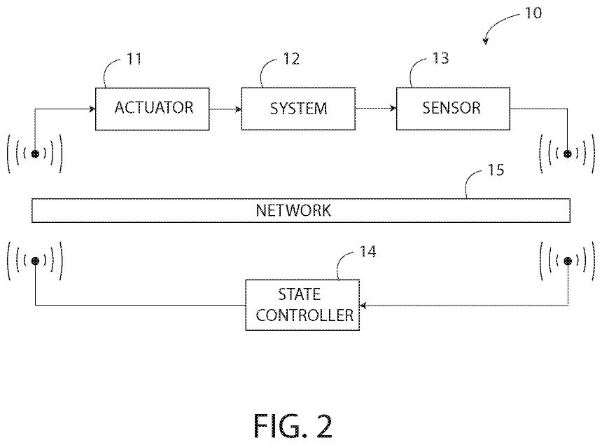

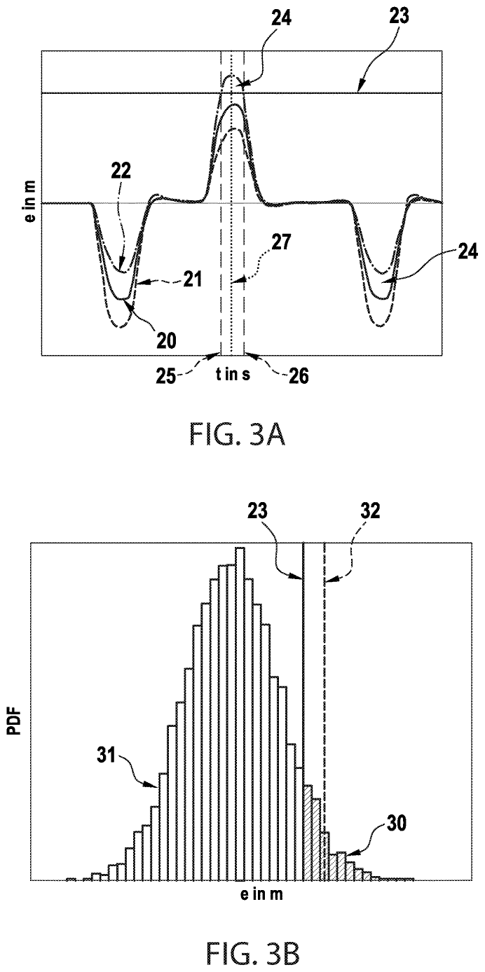

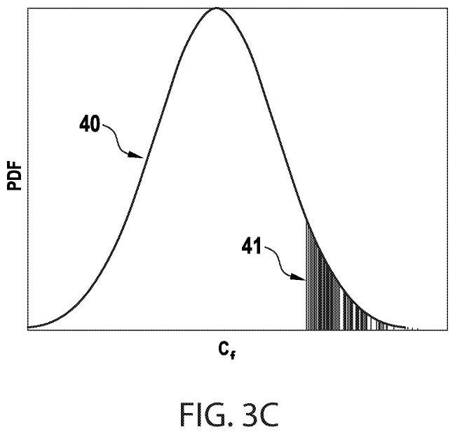

Firstly, techniques for evaluating uncertain time effects when controlling a system on the basis of one or more state variables of the system are described using FIGS. 1A, 1B, 1C, and 1D and FIG. 2. Subsequently, exemplary results for the lateral error when returning a moving vehicle to a traffic lane will be described using the presented techniques on the basis of FIGS. 3A, 3B, and 3C.

As outlined in FIGS. 1A, 1B, 1C, and 1D, a first general aspect relates to a computer-implemented method for evaluating uncertain time effects when controlling a system based on one or more state variables of the system. The method steps of certain aspects of the disclosure are shown in the boxes drawn by solid lines in FIGS. 1A, 1B, 1C, and 1D, while method steps of other aspects of the disclosure are shown in the boxes illustrated with dashed lines.

The first step of the method comprises receiving 100 a time-continuous dynamic model (in the above-defined sense) for describing the system to be controlled, wherein the dynamic model is represented by a specified function ƒ(x, u, ζ) The specified function of the first aspect includes the following time-dependent arguments: a state vector x comprising one or more state variables; an input vector u comprising one or more input variables and associated with the state vector x via a feedback matrix K describing the state controller of the system. In some cases, the input vector u may comprise two or more, three or more, or four or more input variables. In one example, a control law may describe the influence of the state vector x using the feedback matrix K to input the result of this influence into the system to be controlled as an input vector u. In one example, the control law may be expressed by way of the equation uⁱ=Kᵢⱼx^{j} from which the input vector u is formed (i and j refer to the components of the input or state vector). In one example, it is possible to account for immeasurable state variables (x^{j})) that are associated with disappearing feedback matrix components Kᵢⱼ=0 for all i≥1. i may refer to the row index and j to the column index of the feedback matrix. This is an example of a limited definition set K∈ [symbol] .

The system 12 to be controlled (e.g., a system for transverse guidance and/or longitudinal guidance of a vehicle or another system as discussed above) is shown by way of example in FIG. 2. In some cases, the state controller 14 may output the input vector u to one or more actuators. In some examples, the input vector u may be output to the one or more actuators via a network 15. An example of such an actuator 11 is shown in FIG. 2. Moreover, the state controller 14 may receive the state vector x from one or more sensors and/or one or more state estimators of system 12 to be controlled (e.g., via network 15). An example of such a sensor 13 is shown in FIG. 2. In some examples, network 15 may be a wired and/or wireless network. In some examples, the network may comprise a LAN (Local Area Network), a WLAN (Wireless Local Area Network), CAN (Controller Area Network), an IoT network, a 5G network, or a multi-access edge computing network. In some examples, the state controller 14 may be run in a cloud or edge (other examples described above).

Moreover, the specified function of the first aspect as a time-dependent argument includes an uncertainty vector p(ζ) having at least one component comprising a time-dependent uncertainty parameter describing a stochastic process linked to an uncertain time effect. In some cases, the uncertainty vector p(ζ) may comprise one or more, two or more, three or more, or four or more components. The temporal uncertainties may be expressed (at least in part) by a stochastic argument ζ. The stochastic argument ζ may be a random vector, whose components are the random numbers generated according to a specified statistical distribution. In some cases, the statistical distribution may be a zero-mean, normalized uniform distribution. For example, the distribution may be written as follows ζ₁~U(−1,1).

In the techniques of the present disclosure, the uncertainty vector p(ζ) may comprise a delay parameter τ(ζ), which represents a time delay in the system to be controlled (in the sense defined above) and is based on a specified statistical distribution. The specified statistical distribution may be a uniform distribution, a normal distribution, a Poisson distribution, a Wigner-Dyson distribution or another distribution. In one example, the input vector u may be dependent on the delay parameter τ(ζ). The delay parameter may depict a time-uncertain delay of the input vector (u(t−τ(ζ)). In one example, the input vector (u(t−τ(ζ)) may be calculated at a different location than the system to be controlled, so that a time delay may occur due to the data transfer. In some examples, the delay parameter τ(ζ) may be uniformly distributed. In some examples, the following may apply: T∈U(τ⁻, τ⁺), wherein τ⁻ and τ⁺ indicate a minimum and maximum value for the delay parameter. In a particular case, the delay parameter may be represented by isoprobabilistic transformations. For example, the following may apply:

$$τ = \frac{{τ}^{+} + {τ}^{-}}{2} + {ζ}_{1} \frac{{τ}^{+} - {τ}^{-}}{2} ,$$

wherein ζ₁ is defined in the previous paragraph.

Alternatively or additionally, the uncertainty vector p(ζ) of the first aspect may comprise at least one disturbance parameter θ(ζ) that represents a time disturbance of the system to be controlled and is based on a specified statistical distribution (in other words, given by a specified statistical distribution). The specified statistical distribution may be a uniform distribution, a normal distribution, a Poisson distribution, a Wigner-Dyson distribution or another distribution. The disturbance parameter may describe an external or internal disturbance of the system, as already defined above. In the context of the present disclosure, it is also conceivable that the uncertainty vector may comprise one or more, two or more, three or more, five or more disturbance parameters, wherein each disturbance parameter is based on a (corresponding) specified statistical distribution.

The time-continuous dynamic model of the presented techniques may comprise a state matrix Ā(θ(ζ)) and an input matrix B̅(θ(ζ)), wherein the state matrix and/or the input matrix are dependent on the at least one disturbance parameter (θ(ζ)). In one example, if the uncertainty vector p(ζ) comprises a delay parameter t(ζ) and at least one disturbance parameter θ(ζ) (as already discussed above), the time-continuous state-space model may be described by the equation

\dot{x}=Ā(θ(ζ))x(t,ζ)+B̅(θ(ζ))u(t−τ(ζ)), where t>t₀,x(t₀)=x₀(θ(ζ))

In this case, x₀ is an initial state vector assigned to an initial time t₀. As already described above, the input vector u may be determined by the feedback matrix K and the state vector x (in other words: determined by the control law). For example, the following may apply: u(t)=Kx(t). In one example, the feedback matrix K may be time-variant, time-invariant, or constant. In one example, the feedback matrix K may be deterministic. As a result, the time-continuous dynamic model may comprise a state vector x(t, ζ) that is dependent on the statistical distribution (or the distributions).

The next step of the method comprises forming 150 a time-discrete representation of the time-continuous dynamic model by time discretizing the time-continuous dynamic model.

Alternatively or in addition to the delay and disturbance parameters described above, the uncertainty vector p(ζ) may comprise a sampling time h(ζ) that is based on a specified distribution. The specified statistical distribution may be a uniform distribution, a normal distribution, a Poisson distribution, a Wigner-Dyson distribution or another distribution. In that case, the time discretization of the time-continuous dynamic model in the present disclosure may be performed using this sampling time (e.g., the specified function ƒ(x, u, p(ζ)) is sampled with its continuous arguments). In one example, the sampling may be performed for a plurality of time steps tₖ. A particular time step of the plurality of time steps may be formed by a multiple of the sampling time h(ζ). The multiple may be expressed by a running index parameter k. For the plurality of time steps tₖ, the following may apply: tₖ=kh(ζ), k=0, 1, 2, . . . . The time t in the time-continuous dynamic model may assume a value that is between a first sampling time point and a second sampling time point. In some examples, the second sampling time point may be formed by adding the first sampling time point and the sampling time. In some examples, the time t in the time-continuous state-space model may be: t∈[tₖ, tₖ+h(ζ)]. In some examples, the sampling time h(ζ) may be uniformly distributed. In some examples, the following may apply: h∈U(h⁻, h⁺), where h⁻ and h⁺ indicate a minimum and maximum value for the sampling time.

Forming 150 the time-discrete representation of the time-continuous dynamic model may include translating a general solution of the time-continuous state-space model to a time-discrete time domain. In some examples, in the discrete time domain, a piecewise constant input vector may be assumed between an initial time point t₀ and a time point tₖ. In some examples, the initial time point t₀ may be fixed at any one of the first (integer) multiples l of the sampling time h(ζ). The time t may be determined at a second (integer) multiple k>l of the sampling time h(ξ). The second multiple may be a multiple that is subsequent to the first multiple or another multiple. In the examples, the following may apply: t₀=lh(ζ), tₖ=kh(ζ), where l=0, 1, 2, . . . and k are one of l+1, l+2, l+3 (in other words, the determination of the initial time point is not limited). In one example, the time-discrete representation of the time-continuous dynamic model (after time discretization) may appear as follows:

zₖ₊₁=A(h(ζ),τ(ζ),θ(ζ))zₖ+B(h(ζ),τ(ζ),θ(ζ))uₖ,k=1,2,3, . . .

xₖ(ζ)=Czₖ,

wherein A(h(ζ), θ(ζ), θ(ζ)) and B(h(ζ), τ(ζ), θ(ζ)) are a state matrix and an input matrix in the time-discrete representation, and C is a matrix connecting xₖ and zₖ.

Furthermore, the techniques of the present disclosure include determining 200 a surrogate model of the time-discrete representation of the state-space model. It should be noted that an advantage of the time-discrete representation of the time-continuous dynamic model described above may be that the dependence on the uncertain sampling time h(ζ) shifts to the state matrix A(h(ζ), τ(ζ), θ(ζ)) and the input matrix B(h(ζ), τ(ζ), θ(ζ)). This may allow determining 200 the surrogate model.

In the presented techniques, the method step “determining 200 the surrogate model” may include establishing 205 one or more polynomial base functions that are functions of the uncertainty vector p(ζ). In some examples in which the uncertainty vector p(ζ) contains the sampling time h(ζ), the delay parameter t (ζ), and the at least one disturbance parameter θ(ζ), the uncertainty vector may be written as follows: p(ζ)=[h(ζ), τ(ζ), θ(ζ)]^{T}. As discussed above, the uncertainty vector may comprise only one component or two of the components of sampling time, delay parameter, and disturbance parameter.

Furthermore, determining 200 the surrogate model of the time-discrete representation of the state-space model may include performing 210 a series expansion of the state vector xx into a series of the one or more polynomial base functions φₙ(p(ζ)), wherein one or more respective expansion coefficients of the series expansion are independent of the uncertainty vector. In one example, the one or more polynomial base functions may be at least one of Hermite polynomials, Legendre polynomials, Jacobi polynomials, and/or generalized Laguerre polynomials. In one non-limiting example, the series expansion of the state vector may be expressed as follows:

$${x}_{k} ( p ( ζ ) ) = C {\sum }_{n = 1}^{N} {Z}_{k , n} {ϕ}_{n} ( p ( ζ ) ) = {CZ}_{k}^{T} ϕ ( p ( ζ ) ) .$$

The matrix C is defined above. Here, φₙ(p(ζ)) are polynomial base functions (in total N in this example), and Zₖ^{T} are the corresponding expansion coefficients, with index k numbering the time steps (e.g., tₖ=t₀+kh(ζ)). The superscript T here stands for the transposition. In one example, the variable N may be predefined. For example, a larger N may result in a more accurate approximation but may necessitate a longer computational time and a smaller N may result in a more inaccurate approximation but may allow for shorter computational time.

In some cases, determining the surrogate model may occur using polynomial chaos development.

Moreover, the method step “determining 200 the surrogate model” may comprise projecting 215 the formed time-discrete representation of the time-continuous dynamic model onto the one or more polynomial base functions. In the present disclosure, projecting 215 the formed time-discrete representation of the time-continuous dynamic model may be performed by integrating the formed time-discrete representation of the time-continuous dynamic model multiplied by respective functions comprising the polynomial base functions, wherein the integration takes place in a space of the uncertainty vector and thereby forms a number of projection integrals. In some cases, the surrogate model may comprise a plurality of matrices after projecting the formed time-discrete representation of the time-continuous dynamic model, wherein each matrix of the plurality of matrices comprises one or more projection integrals. In one example, the projected formed time-discrete representation of the time-continuous dynamic model may comprise one or more products of the one or more respective matrices of the plurality of matrices with the corresponding expansion coefficients of the series expansion. For example, the projected formed time-discrete representation of the time-continuous dynamic model may be equal to the product if only one product is present, or a sum of products if more than one product is present.

In the context of the present disclosure, it is also conceivable that the method step “determining 200 the surrogate model” further comprises calculating the one or more expansion coefficients

$$( {Z}_{k + 1}^{T} )$$

for a next time step (e.g., tₖ₊₁=(k+1)h(ζ) based on the one or more expansion coefficients

$$( {Z}_{k}^{T} )$$

for a previous time step (e.g., tₖ=kh(ζ)). In that case, the one or more expansion coefficients

$$( {Z}_{k + 1}^{T} )$$

for the next time step may be linked to the one or more expansion coefficients

$$( {Z}_{k}^{T} )$$

for the previous time step by the plurality of matrices (discussed above).

In one example, the determination of the surrogate model may be:

$${Z}_{k + 1} = ( {A}_{PCE} + {B}_{PCE} {K}_{PCE} ) {Z}_{k} , k = 0 , 1 , 2 , 3 with {K}_{PCE} = ( KC ⊗ {I}_{N} ) .$$

$$F = {\int }_{Ω} ϕ ( p ( ζ ) ) {ϕ}^{T} ( p ( ζ ) ) dw ( p ( ζ ) ) ;$$

$${A}_{PCE} = {F}^{- 1} {\int }_{Ω} ϕ ( p ( ζ ) ) A ( p ( ζ ) ) {ϕ}^{T} ( p ( ζ ) ) dw ( p ( ζ ) )$$

$${B}_{PCE} = {F}^{- 1} {\int }_{Ω} ϕ ( p ( ζ ) ) B ( p ( ζ ) ) dw ( p ( ζ ) ) ; {Z}_{0} = {F}^{- 1} {\int }_{Ω} ϕ ( p ( ζ ) ) {z}_{0} dw ( p ( ζ ) ) .$$

Here, Ω is an area of the common probability density function (PDF) of the uncertainty vector p(ζ). A differential may be provided by the expression dω(p(ζ))=ρ(p(ζ))dp(ζ). For further details on surrogate models, see, for example, the patent application “Computer-implemented method for determining a surrogate model of a state-space model”, DPMA file number: 102023206821.4.

The next step of the method comprises solving 250 the surrogate model to determine a mean [symbol] (xₖ) of the state vector xₖ and a deviation [symbol] (xₖ), in particular a variance, of the state vector xₖ at a plurality of discrete time points tₖ. In this case, the mean and the deviation (or variance) of the state vector xₖ obtained as part of the surrogate model without the use of sampling as in the presented techniques may correspond to (e.g., approximate) a mean and a deviation (or variance) of the state vector that may be determined using a large number of samples (e.g., more than 10³ samples) for the uncertainty vector using UQ methods (e.g., Monte Carlo simulation or Latin hypercube sampling). In other words, by using the surrogate model, it is possible that, when determining the mean and the deviation (or variance) of the state vector xₖ at the plurality of discrete time points tₖ, no sampling is required, which may represent a significant increase in efficiency over a large number of simulations (e.g., more than 10³ simulations) using UQ methods.

In the presented techniques, determining the mean [symbol] (xₖ) of the state vector xx and the deviation, in particular the variance [symbol] (xₖ), of the state vector xx at the plurality of discrete time points tₖ is performed using the one or more expansion coefficients

$${Z}_{k}^{T}$$

or the surrogate model for these time points. In a non-limiting example, the mean [symbol] (xₖ) and variance [symbol] (zₖ) of the state vector x at the plurality of discrete time points may be determined by the following expressions:

[symbol]

[xₖ]=CMZₖ, [symbol] [xₖ]=CVZₖ²,

where C, M and V are the corresponding matrices.

The next method step comprises searching 300 for one or more discrete time points t*ₖ from the plurality of discrete time points using the determined mean of the state vector xₖ and the determined deviation, in particular the variance, of the state vector xx, for which a specified rough requirement criterion for the state vector is not satisfied.

Subsequently, the presented techniques comprise classifying 400 the uncertain time effects as critical for controlling the system if the one or more discrete time points t*ₖ have been identified, for which the rough requirement criterion for the state vector is not satisfied, and otherwise (i.e., if no such discrete time points have been identified) classifying 600 the uncertain time effects as non-critical for controlling the system. These identified time points are also referred to hereinafter as “critical time points.”

Furthermore, the techniques of the present disclosure may comprise calculating a confidence interval for the state vector using the determined mean of the state vector xₖ and the determined deviation, in particular the variance, of the state vector xx at the plurality of discrete time points. The specified rough requirement criterion may comprise that the state vector, which is in the confidence interval, is less than a specified maximum state value and/or is greater than a specified minimum state value. In other words, If, for a discrete time point t*ₖ (from the plurality of discrete time points), there is at least one value of the state vector within the confidence interval for that discrete time point that reaches or exceeds the specified maximum state value and/or reaches or falls below the specified minimum state value, then that discrete time point

$${t}_{k}^{*}$$

may be classified as the time point, for which the specified rough requirement criterion is not satisfied (i.e., the confidence interval contains the specified maximum and/or minimum state value for that discrete time point). In the context of the present disclosure, it is conceivable that if the state vector comprises more than one state variable (i.e., more than one component), a corresponding specified rough requirement criterion may be formulated for each state variable (i.e., for each component of the state vector) (for simplicity, the following discussion sometimes refers only to the state vector).

In the example of FIG. 3A(discussed in more detail below), the time points

$${t}_{k}^{*}$$

within the time interval between the time points 25 and 26 are the “critical time points” (i.e., the specified rough requirement criterion is not satisfied for them), because, for this time interval, the state vector (taking into account its confidence interval) exceeds the specified maximum state value 23. In one example, the confidence interval may be defined by a lower limit x_{LB}(tₖ); 21 and an upper limit x_{UB}(tₖ); 22 that T run within a time interval. In a specific example, these lower and upper limits may be given by the formula:

x_{LB/UB}(tₖ)= [symbol] [xₖ]±l [symbol] l=1,2,3, . . .

In the context of the present disclosure, it is conceivable that if the one or more discrete time points have been identified, for which the rough requirement criterion for the state vector is not satisfied, the method may further comprise changing 410 the uncertainty vector p(ζ) by reducing a level of uncertainty in the uncertain time effect that is associated with the at least one component of the uncertainty vector p(ζ) (i.e., the corresponding time-dependent uncertainty parameter). In the examples, the level of uncertainty in the uncertain time effect may be reduced by a corresponding change of a specified statistical distribution describing an uncertainty parameter. For example, the width of the distribution may be decreased, or its specified shape may be changed. In addition, the next method step may comprise re-solving 420 the surrogate model with the changed uncertainty vector to determine a changed mean [symbol] (xₖ) of the state vector xₖ and a changed deviation, in particular a changed variance [symbol] (xₖ), of the state vector zₖ at the plurality of discrete time points tₖ. Furthermore, the method may comprise checking 430 whether the specified rough requirement criterion for the state vector is satisfied at the plurality of discrete time points tₖ based on the determined changed mean of the state vector xₖ and the determined changed deviation, in particular the changed variance, of the state vector xₖ. Changing the uncertainty vector may be performed until the specified rough requirement criterion for the plurality of discrete time points is satisfied. It may thus be determined, for which parameter ranges of the uncertainty parameter the specified rough requirement criterion is satisfied (and for which it is not). In this manner, this method may be performed for more than one uncertainty parameter (e.g., for all uncertainty parameters) if the uncertainty vector comprises p(ζ) more than one uncertainty parameter.

In addition, when the one or more discrete time points have been identified, for which the rough requirement criterion for the state vector is not satisfied, the techniques of the present disclosure may further comprise calculating 440 one or more statistical distributions

$${f}_{s} ( {x}_{k}^{*} )$$

for the state vector at the respective one or more identified discrete time points using a number of samples for the uncertainty vector and the surrogate model. For example, the natural number nₛ may indicate the number of samples. nₛ may be equal to or greater than 10, equal to or greater than 10², equal to or greater than 10³, or equal to or greater than 10⁴. In some examples, the samples for the uncertainty vector may be grouped into a matrix. For example, p(ζ)⁽¹⁾∈ [symbol] ⁿ^{ₚ} may represent the first sample for the uncertainty vector, comprising nₚ components (i.e., nₚ uncertainty parameters). In this case, nₚ=1 may be nₚ=2, nₚ=3, or any other natural number. In some examples, each sample for the uncertainty vector may be presented in the same manner. In some examples, the matrix for the sampled uncertainty vector may be written as follows:

p(ζ)ₛ=[p(ζ)⁽¹⁾,p(ζ)⁽²⁾, . . . p(ζ)⁽ⁿ^{ₛ}⁾]∈ [symbol] ⁿ^{ₚ}^{×n}^{ₛ}.

In some cases, a sample (e.g., each sample) for the uncertainty vector p(ζ)^{(l)} (l=1, 2, 3, . . . ) may be calculated using the one or more specified statistical distributions for the respective one or more uncertainty parameters that occur as components in the uncertainty vector (also see the discussions above). For the same purpose, in some cases random numbers may also be generated for the stochastic argument ζ, as already explained above.

In the presented techniques, calculating 440 the one or more statistical distributions for the state vector at the respective one or more identified discrete time points may further comprise calculating 445 the one or more polynomial base functions for the number of samples for the uncertainty vector (in other words, for the sampled uncertainty vector) to determine a number of samples for the one or more polynomial base functions

$${ϕ}_{n}^{S} ( p ( ζ ) )$$

Furthermore, the method step “calculating 440” may comprise calculating 450 a number of empirical (in other words, sampled) state vectors

$${x}_{k}^{S}$$

using the determined number of samples for the one or more polynomial base functions

$${ϕ}_{n}^{S} ( p ( ζ ) )$$

and the one or more respective expansion coefficients

$${Z}_{k}^{T}$$

of the series expansion. For example, an empirical state vector

$${x}_{k}^{S}$$

may be calculated as the sum of products, wherein each product may represent a product of a sampled polynomial base function and a corresponding expansion coefficient. In this manner, in some cases, each empirical state vector may be determined. In one example and in accordance with the above definitions, the empirical state vectors

$${x}_{k}^{S}$$

may be calculated as follows.

$${x}_{k}^{S} ( p ( ζ ) ) = C {\sum }_{n = 1}^{N} {Z}_{k , n} {ϕ}_{n}^{S} ( p ( ζ ) ) = C {Z}_{k}^{T} {ϕ}_{n}^{S} ( p ( ζ ) ) .$$

An advantage of the method disclosed here may be that this procedure may specifically enable the determination of the stochastic distribution

$${f}_{s} ( {x}_{k}^{*} )$$

for the state vector at the critical times

$${t}_{k}^{*}$$

with a single simulation of the surrogate model instead of nₛ simulations of the (original) dynamic model. In particular, the empirical state vectors xx may be calculated using expansion coefficients

$${Z}_{k}^{T} ,$$

the determination of which requires only a simulation of the surrogate model (i.e., no samples are used for these expansion coefficients, as exemplified in the formula above).

In one case, only a single statistical distribution may be calculated for the state vector for a single identified discrete time point. For example, an identified discrete time point may be selected, for which the upper limit of the confidence interval x_{UB}(tₖ) assumes a maximum value or the lower limit of the confidence interval x_{LB}(tₖ) assumes a minimum value (in a considered time interval). This is illustrated by way of example in FIG. 3A, in which the identified discrete time point 27 is selected, for which the upper limit of the confidence interval x_{UB}(tₖ) assumes a maximum value (in this example, the lateral error e is shown as a function of time t). For this discrete time point 27, the calculated distribution

$${f}_{s} ( {x}_{k}^{*} )$$

(more specifically, the probability distribution function, PDF) is exemplarily shown in FIG. 3B (more below). In another example, statistical distributions may be calculated for the state vector relative to the other (e.g., all) identified discrete time points.

If the one or more discrete time points have been identified, for which the rough requirement criterion for the state vector is not satisfied, the method may further comprise determining 460 one or more characteristics relative to the state vector at the one or more identified discrete time points using the respective one or more statistical distributions for the state vector. The one or more characteristics may take on different values for different identified discrete time points (i.e., the time points, at which the specified rough requirement criterion is not satisfied according to the above discussions).

In the present disclosure, the one or more characteristics may comprise a first characteristic describing a probability of error, with which the specified rough requirement criterion for the state vector is not satisfied. For example, the first characteristic may be a value-at-risk. The value-at-risk may indicate a probability that the selected value is exceeded or not met (i.e., the probability of error). The value-at-risk may, for example, be expressed as follows:

$${VaR}_{α} ( {x}_{k}^{*} ) = {F}_{s}^{- 1} ( 1 - α ) ,$$

where

$${F}_{s}^{- 1}$$

is an inverse empirical distribution function (in other words, a quantile function) for the state vector

$${x}_{k}^{*}$$

(e.g., for a component of that state vector) at an identified discrete time point

$${t}_{k}^{*} ,$$

and α denotes the probability of error. The inverse empirical distribution function may be calculated using known prior art methods from the corresponding one or more statistical distributions

$${f}_{s} ( {x}_{k}^{*} )$$

for the state vector. Returning to the above example, if the specified rough requirement criterion comprises that the state vector, which is in the confidence interval, is less than the specified maximum state value and/or greater than the specified minimum state value: In this case, one of the specified maximum or minimum state values may be used as a value-at-risk

$${VaR}_{α} ( {x}_{k}^{*} ) .$$

This is further clarified by the example of FIG. 3B, in which the specificized maximum state value 23 from FIG. 3A was selected as a value-at-risk

$${VaR}_{α} ( {x}_{k}^{*} )$$

(and also provided with the same reference numeral 23 in FIG. 3B). The shaded area 30 of the indicated distribution (PDF), which may describe the probability that the state vector will take on higher values than the value-at-risk

$${VaR}_{α} ( {x}_{k}^{*} ) ,$$

may correspond to the probability of error α. Accordingly, the unshaded region 31 of the indicated distribution (PDF) may describe a probability 1−α that the state vector will assume values that are lower than the value-at-risk

$${VaR}_{α} ( {x}_{k}^{*} )$$

(i.e., no error occurs).

Moreover, the one or more characteristics may comprise a second characteristic characterizing an extent, to which the specified rough requirement criterion is not satisfied. In some cases, the second characteristic may be associated with the first characteristic. For example, the second characteristic may be a conditional value-at-risk. The conditional value-at-risk may be used to calculate an expected value for the portion of the statistical distribution

$${f}_{s} ( {z}_{k}^{*} ) ,$$

for which the value-at-risk is exceeded or not met (in other words, for which a violation is present). The conditional value-at-risk may, for example, be expressed as follows:

$${CVaR}_{α} ( {x}_{k}^{*} ) = E ( {x}_{k}^{*} \vert {x}_{k}^{*} > {VaR}_{α} ( {x}_{k}^{*} ) ) ,$$

where

$${VaR}_{α} ( {x}_{k}^{*} )$$

is the value-at-risk, as introduced above. In the example of FIG. 3B, the conditional value-at-risk is represented by the vertical dashed line 32.

In some cases of the presented techniques, the one or more characteristics may comprise a third characteristic characterizing which of the uncertainty parameters contributes more to a violation of the specified rough requirement criterion and which of the uncertainty parameters contributes less to a violation of the specified rough requirement criterion, if the uncertainty vector comprises at least two uncertainty parameters. In other words, the third characteristic may describe the sensitivity of the state vector to various uncertainty parameters (e.g., two or more uncertainty parameters) (i.e., it may provide information about which uncertainty parameters lead to more significant changes and which lead to less significant changes in the state vector). In one example, the third characteristic may comprise one or more Sobol indices. In that case, these Sobol indices may be used to perform the sensitivity analysis for the state vector discussed above with respect to two or more uncertainty parameters. In the example of FIG. 3C, the normal distribution was assumed to be a specified statistical distribution 40 for an internal time disturbance of the system (the cornering stiffness of the front axle, see below). In this case, the resulting Sobol indices (represented by multiple vertical lines 41) are relatively diffusely distributed under the normal distribution, which may be due to the low sensitivity of the state vector (lateral error in this example) to this internal time disturbance.

Moreover, after performing the method step “determining 460 one or more characteristics,” the method may further comprise classifying 480 the state controller as suitable for controlling the system if the one or more characteristics with respect to the state vector satisfy a specified fine requirement criterion, and otherwise adjusting 500 the uncertainty vector p(ζ) or adjusting 550 the state controller. In some cases, the specified fine requirement criterion may comprise the one or more characteristics relative to the state vector being less than one or more corresponding specified threshold values. For example, if the first characteristic is the value-at-risk

$${VaR}_{α} ( {x}_{k}^{*} ) ,$$

a threshold value for the probability of error α may be defined as: If the probability of error α is less than this threshold value, this may mean that the specified fine requirement criterion is satisfied. In other cases, such as when the one or more characteristics are defined differently, the specified fine requirement criterion may comprise the one or more characteristics relative to the state vector being greater than one or more respective specified threshold values.

In addition, adjusting 500 the uncertainty vector p(ζ) may comprise adjusting 510 the uncertainty vector p(ζ) by reducing a level of uncertainty in the uncertain time effect associated with the at least one component of the uncertainty vector p(ζ). As already mentioned above, the level of uncertainty in the uncertain time effect may be reduced by a corresponding change to a specified statistical distribution describing an uncertainty parameter. For example, the width of the distribution may be decreased, or its specified shape may be changed. Furthermore, the next method step may comprise re-solving 520 the surrogate model with the adjusted uncertainty vector. Furthermore, the method may comprise calculating 530 one or more adjusted statistical distributions

$${f}_{s} ( {x}_{k}^{*} )$$

for the state vector at the respective identified discrete time points using a number of samples for the adjusted uncertainty vector and the surrogate model. The next method step may comprise determining 540 one or more adjusted characteristics relative to the state vector at the one or more identified discrete time points using the respective one or more adjusted statistical distributions for the state vector. The adjustment of the uncertainty vector may be performed as long as the specified fine requirement criterion for the one or more adjusted characteristics is not satisfied.

In the techniques of the present disclosure, adjusting 520 the state controller (which is the alternative to adjusting 500 the uncertainty vector p(ζ)) may comprise solving 560 a stochastic optimization problem using the surrogate model to determine an adjusted feedback matrix K of the state controller, wherein the stochastic optimization is performed using a target function that may be based on the surrogate model. In the examples, for the purpose of solving the stochastic optimization problem, the mean values [symbol] (xₖ) and the variances [symbol] (xₖ) of the state vector zₖ at the plurality of discrete time points tₖ may be determined as part of the surrogate model. The stochastic optimization may include minimizing the target function. For further details on the optimization problem, see, for example, the patent application “computer-implemented method for designing a state controller with stochastic optimization”, DPMA file number: 102023203084.5. In some cases, the specified fine requirement criterion for the state vector may be satisfied for the adjusted state controller described by the adjusted feedback matrix K.

The advantages of the techniques of the present disclosure over the prior art have already been discussed with reference to FIGS. 3A, 3B, and 3C. In these figures, the results of returning a moving car to a traffic lane during a driving maneuver are shown. In this non-limiting example, the state vector xₖ=[\dot{ψ}ₖ, eₖ, βₖ] is composed of three components, namely a yaw rate \dot{ψ}ₖ, a lateral error eₖ and a side slip angle βₖ, while the input vector uₖ=[δₖ] contains the steering angle δₖ as a single component (the index k denotes a time point as defined above). A time delay τ in sensor signal acquisition and the cornering stiffness of the front axle c_{ƒ} of a vehicle are considered as uncertainty parameters. That is why the uncertainty vector p(ζ) consists of two components in this example, p(ζ)=[τ(ζ), c_{ƒ}(ζ)]. For the cornering stiffness of the front axle c_{ƒ}(ζ), the normal distribution was assumed as the specified statistical distribution (represented by curve 40 in FIG. 3C), whereas for the time delay τ(ζ), the uniform distribution was selected as an example (not shown in the figures).

FIG. 3A illustrates, by way of example, a resulting response of a specified state controller (i.e., its feedback matrix K is known) using the surrogate model according to techniques of the present disclosure: The mean value of the lateral error [symbol] (eₖ) is shown by the solid curve 20, and its confidence interval between the lower limit e_{LB}(tₖ) and the upper limit e_{UB}(tₖ) is shown by two dashed curves 21 and 22. (This example is calculated for e_{LB/UB}(tₖ)= [symbol] [eₖ]±l [symbol] with l=3.) The “critical time points” are located in the time interval between the time points 25 and 26 (i.e., the specified rough requirement criterion is not satisfied for them): For these critical time points, the confidence interval 24 for the lateral error overlaps with the maximum allowable lateral error 23 (“specified maximum state value”). For the “critical time point 27,” at which the lateral error eₖ assumes the maximum value, the distribution

$${f}_{s} ( {e}_{k}^{*} )$$

(the probability distribution function, “PDF”) is shown in FIG. 3B. The value-at-risk VaR_{α}(e*ₖ), represented by the solid vertical line 23 in FIG. 3B, corresponds to the maximum allowable lateral error 23 from FIG. 3A. The shaded region 30 with values for the lateral error greater than

$${VaR}_{α} ( {e}_{k}^{*} )$$

corresponds to the probability of error α, while the non-shaded region 31 of the indicated distribution (PDF) describes a probability 1−α. In FIG. 3B, the conditional value-at-risk is represented by the vertical dashed line 32. In the example of FIG. 3C, the resulting Sobol indices (represented by a plurality of vertical lines 41) are distributed relatively diffusely under the normal distribution 40 for the cornering stiffness of the front axle c_{ƒ}(ζ), indicating a low sensitivity of the lateral error to the c_{ƒ}(ζ). In contrast, in this example, the resulting Sobol indices are located near the boundaries of the uniform distribution for the time delay τ(ζ), which means high sensitivity of the lateral error to the τ(ζ) (not shown in the figures).

In addition, a computer program is disclosed, which is designed to perform the computer-implemented method for evaluating uncertain time effects when controlling a system based on one or more state variables of the system according to the first general aspect. The computer program may, for example, be present in interpreted or compiled form. For execution, it may be loaded (also in portions) into the RAM of a computer, for example, as a bit or byte sequence.

A computer system is further disclosed, which is designed to perform the computer-implemented method for evaluating uncertain time effects when controlling a system based on one or more state variables of the system according to the first aspect and/or the computer program according to the second aspect. The computer system may include at least one processor, at least one memory (which may include programs that, when executed, perform the methods of the present disclosure) and at least one interface for inputs and outputs. The computer system may be a “stand-alone” system or a distributed system that communicates over a network (e.g., the Internet).

A computer readable medium (e.g., a machine readable storage medium such as, for example, an optical storage medium or memory, e.g., FLASH memory) or signal is further disclosed, which stores and/or contains the computer program according to the second general aspect.

1. A computer-implemented method for evaluating uncertain time effects when controlling a system based on one or more state variables of the system, the method comprising:
receiving a time-continuous dynamic model for describing the system to be controlled, wherein the time-continuous dynamic model is (ƒ(x, u, p(ζ))) represented by a specified function containing time-dependent arguments comprising:
a state vector (x) comprising one or more state variables;
an input vector (u) comprising one or more input variables, which input vector is connected to the state vector (x) by a feedback matrix (K) describing a state controller of the system; and
an uncertainty vector (p(ζ)) with at least one component comprising a time-dependent uncertainty parameter representing a stochastic process associated with an uncertain time effect;
forming a time-discrete representation of the time-continuous dynamic model by time discretizing the time-continuous dynamic model;
determining a surrogate model of the time-discrete representation of a state-space model;
solving the surrogate model to determine a mean (E(xₖ)) of the state vector (xₖ) and a deviation, in particular a variance (V(xₖ)), of the state vector (zₖ) at a plurality of discrete time points (tₖ);
searching for one or more discrete time points (t*ₖ) from the plurality of discrete time points using the determined mean of the state vector (xₖ) and the determined deviation, in particular the variance, of the state vector (xₖ), for which a specified rough requirement criterion for the state vector is not satisfied; and
classifying the uncertain time effects as critical for controlling the system if the one or more discrete time points (t*ₖ) have been identified, for which the rough requirement criterion for the state vector is not satisfied, and otherwise classifying the uncertain time effects as non-critical for controlling the system.

2. The method according to claim 1, further comprising:
calculating a confidence interval for the state vector using the determined mean of the state vector (xₖ) and the determined deviation, in particular the variance, of the state vector (xₖ) at the plurality of discrete time points,
wherein the specified rough requirement criterion comprises that the state vector, which is in the confidence interval, is less than a specified maximum state value and/or is greater than a specified minimum state value.

3. The method according to claim 1, wherein, if the one or more discrete time points have been identified, for which the rough requirement criterion for the state vector is not satisfied, the method further comprises:
changing the uncertainty vector (p(ζ)) by reducing a level of uncertainty in the uncertain time effect associated with the at least one component of the uncertainty vector (p(ζ));
re-solving the surrogate model with the changed uncertainty vector to determine a changed mean (E(xₖ)) of the state vector (xₖ) and a changed deviation, in particular a changed variance (V(xₖ)), of the state vector (zₖ) at the plurality of discrete time points (tₖ);
checking whether the specified rough requirement criterion for the state vector is satisfied at the plurality of discrete time points (tₖ) based on the determined changed mean of the state vector (xₖ) and the determined changed deviation, in particular the changed variance, of the state vector (xₖ),
wherein changing the uncertainty vector is performed until the specified rough requirement criterion for the plurality of discrete time points is satisfied.

4. The method according to claim 1, wherein, if the one or more discrete time points have been identified, for which the rough requirement criterion for the state vector is not satisfied, the method further comprises:
calculating one or more statistical distributions (ƒₛ(x*ₖ)) for the state vector at the respective one or more identified discrete time points using a number of samples for the uncertainty vector and the surrogate model;
determining one or more characteristics relative to the state vector at the one or more identified discrete time points using the respective one or more statistical distributions for the state vector; and
classifying the state controller as being suitable for controlling the system when the one or more characteristics relative to the state vector satisfy a specified fine requirement criterion, and otherwise adjusting the uncertainty vector (p(ζ)) or adjusting the state controller.

5. The method according to claim 4, wherein the specified fine requirement criterion comprises the one or more characteristics relative to the state vector being less than one or more corresponding specified threshold values.

6. The method according to claim 4, wherein the one or more characteristics comprise one or more of:
a first characteristic describing a probability of error, with which the specified rough requirement criterion for the state vector is not satisfied;
a second characteristic characterizing an extent, to which the specified rough requirement criterion is not satisfied; and
a third characteristic characterizing which of the uncertainty parameters contributes more to a violation of the specified rough requirement criterion and which of the uncertainty parameters contributes less to the violation of the specified rough requirement criterion, if the uncertainty vector comprises at least two uncertainty parameters.

7. The method according to claim 4, wherein adjusting of the uncertainty vector (p(ζ)) comprises:
adjusting the uncertainty vector (p(ζ)) by reducing a level of uncertainty in the uncertain time effect associated with the at least one component of the uncertainty vector (p(ζ));
re-solving the surrogate model with the adjusted uncertainty vector;
calculating one or more adjusted statistical distributions (ƒₛ(x*ₖ)) for the state vector at the respective one or more identified discrete time points using a number of samples for the adjusted uncertainty vector and the surrogate model; and
determining one or more adjusted characteristics relative to the state vector at the one or more identified discrete time points using the respective one or more adjusted statistical distributions for the state vector,
wherein the adjustment of the uncertainty vector is performed as long as the specified fine requirement criterion for the one or more adjusted characteristics is not satisfied.

8. The method according to claim 4, wherein adjusting the state controller comprises solving a stochastic optimization problem using the surrogate model to determine an adjusted state controller feedback matrix (K), wherein the stochastic optimization is performed using a target function based on the surrogate model.

9. The method according to claim 1, wherein the uncertainty vector (p(ζ)) comprises uncertainty parameters comprising one or more of:
a delay parameter (τ(ζ)) representing a time delay in the system to be controlled and based on a specified statistical distribution;
at least one disturbance parameter (θ(ζ)) representing a time disturbance of the system to be controlled and based on a specified statistical distribution; and
a sampling time (h(ζ)) based on a specified distribution, wherein the time discretization of the time-continuous dynamic model is performed using the sampling time.

10. The method according to claim 1, wherein determining the surrogate model of the time-discrete representation of the state-space model comprises:
establishing one or more polynomial base functions (φₙ(p(ζ)))) that are functions of an uncertainty vector (p(ζ)),
performing a series expansion of the state vector (xₖ) into a series of the one or more polynomial base functions, wherein one or more respective expansion coefficients (Zₖ^{T}) of the series expansion are independent of the uncertainty vector; and
projecting the formed time-discrete representation of the time-continuous dynamic model onto the one or more polynomial base functions.

11. The method according to claim 4, wherein determining the surrogate model of the time-discrete representation of the state-space model comprises:
establishing one or more polynomial base functions (φₙ(p(ζ)))) that are functions of an uncertainty vector (p(ζ),
performing a series expansion of the state vector (xₖ) into a series of the one or more polynomial base functions, wherein one or more respective expansion coefficients (Zₖ^{T}) of the series expansion are independent of the uncertainty vector;
projecting the formed time-discrete representation of the time-continuous dynamic model onto the one or more polynomial base functions; and
wherein calculating the one or more statistical distributions for the state vector at the respective one or more identified discrete time points further comprises:
calculating the one or more polynomial base functions for the number of samples for the uncertainty vector to determine a number of samples for the one or more polynomial base functions (φₙ^{S}(p(ζ)));
calculating a number of empirical state vectors (xₖ^{S}) using the determined number of samples for the one or more polynomial base functions (φₙ^{S}(p(ζ))) and the one or more respective expansion coefficients (Zₖ^{T}) of the series expansion.

12. The method according to claim 10, wherein determining the surrogate model of the time-discrete representation of the state-space model comprises:
calculating the one or more expansion coefficients (Zₖ₊₁^{T}) for a next time step based on the one or more expansion coefficients (Zₖ^{T}) for a previous time step.

13. The method according to claim 10, wherein determining the mean (E(zₖ)) of the state vector (zₖ) and the deviation, in particular the variance (V(zₖ)), of the state vector (zₖ) at the plurality of discrete time points (tₖ) is performed using the one or more expansion coefficients (Zₖ^{T}) of the surrogate model for these time points.

14. The method according to claim 1, wherein a computer program is configured to perform the computer-implemented method according to claim 1.

15. A computer system comprising:
a processor configured to perform the computer-implemented method according to claim 1.
